(19) United States
(12) Patent Application Publication
(10) Pub. No.: US 2007/0291583 A1
(43) Pub. Date: Dec. 20, 2007

(54) Drink blender system with a single use disposable lid

(76) Inventor: Robert Joseph Baschnagel, Bayside, NY (US)

Correspondence Address: Robert Baschnagel III, 36-17 212 Street, Bayside, NY, 11361, US

(21) Appl. No.: 11/455,332

(22) Filed: Jun. 19, 2006

(51) Int. Cl. A47J 43/046

(52) U.S. Cl. 366/205

(57) ABSTRACT

A drink blender system with a single use lid permitting a user to dispose of the lid and mixing apparatus after use. The drink blender system with a single use lid includes a lid defining an upper end and a lower end. The upper end of the lid having an opening into the interior. A ribbed wall, on both the exterior and interior of the lid, allowing for the lid to mate with a correspondingly ribbed cup on the interior and a correspondingly ribbed base wall on the exterior. A mixing apparatus is integrally formed as a single unit with the lid. The mixing apparatus extends upwardly from the lower end into the interior of the lid. The lid is formed of a substantially rigid plastic material, where the mixing apparatus comprises a metal blade with a plastic 6-tooth driver mate supported by a metal support. A driver assembly for driving the mixing apparatus to mix the constituents of the drink.

### BACKGROUND OF THE INVENTION

1. Field of the Invention

The present invention relates to food blenders and more specifically relates to a new drink blender system with a single use disposable lid for providing the user with a safe and relatively low cost system that permits a user to dispose of the lid and its attendant mixing apparatus after a single use.

2. Description of the Prior Art

The use of food blenders is known in the prior art. More specifically, food blenders heretofore devised and utilized are known to consist basically of familiar, expected and obvious structural configurations, notwithstanding the myriad of designs encompassed by the crowded prior art which have been developed for the fulfillment of countless objectives and requirements. In addition to meeting the particular objectives and requirements, food blenders can be difficult to clean and thus making food blenders less than desirable to use.

U.S. Pat. No. 6,338,569 to McGill shows a food blending apparatus for blending products in a container where the container is made to be disposed of after the product in the container has been consumed and requires a complex sealing means to ensure that the food within the container does not leak out between the lid and the blender and the blender that, extends through the lid and therefore increases the cost of the container. Also this apparatus is more apt for mixing, with the blending apparatus being comprised of entirely plastic components, which is not conducive to create the requisite vortex or pressure to pulverize coarser and otherwise more granular particles. U.S. Pat. No. 6,616,323 to McGill shows a food blending apparatus with a blender extending through a closure member of a container with the blender member being capable of being slid up and down in the container to blend the material in the container and allow disposal of the container after use while requiring a complex system for permitting a closure member to be inserted into the upper opening and sealing the upper opening while allowing a blender member to be coupled to closure member to allow the material in the container to be blended which adds complexity and additional cost. U.S. Pat. No. 6,854,875 to McGill shows a food blending apparatus for blending products that provides the materials in the container with the container to be disposed of after the material has been dispensed from the container as in U.S. Pat. No. 6,338,569 requires a complex sealing means to ensure that the food within the container does not leak out between the lid and the blender that extends through the lid and therefore increases the cost of the container as well as a plastic blade being an impracticable and potentially health-hazardous alternative to metal due to chipping and the like.

U.S. Pat. No. 6,071,006 to Hochstein shows a container for vending machines with a stirring shaft extending into the container from a cover. The stirring shaft extending into the container from a cover. The stirring shaft is rotated by a rotating device to mix the contents of the container with the cover being removed or pierced to gain access to the contents of the container, the process by which the container and stirring shaft are constructed increase the cost to produce the container. U.S. Pat. No. 1,519,798 to Pilkington shows a drink mixer that incorporates a stirrer in a glass to allow the contents of the glass to be mixed when the stirrer is rotated. The use of a glass container makes it cost prohibitive to dispose of the container after each use and therefore requires the user to clean the container after each use. U.S. Pat. No. 5,855,431 to Costanzo shows a rotating mixer and tray with a container with a whisk that extends through the base of the container and is coupled to a gear under the base of the container which rotates the whisk to stir the contents of the liquid when the gear is rotated by the motor in the motor housing unit, additionally, the container is intended to be reused and therefore requires the user to clean the container after every use.

U.S. Pat. No. 6,709,150 to Lin shows a juice blender having a container with a horizontal partition formed with a skirt and blades on a rotor positioned in the container for mixing the materials in the container. A coupler is positioned in the skirt of the container and engages a motor to turn the rotor and blades to mix the contents of the container. Additionally, the container is not intended to be discarded after every use and therefore requires the user to clean it after every use. U.S. Pat. No. 5,639,161 to Sirianni shows a pressured switch-controlled blender cup apparatus with a hollow base that houses a motor, power supply, and a variety of switches and a propeller coupled to the rotor of the motor extending through the bottom wall and into the cup and mixing materials in the cup when the cup is placed in the surface. The cup is not intended to be disposed of after each use and therefore requires cleaning of the cup and the propeller after each use. U.S. Patent Application No. 2005/11055205 to Baschnagel purports to show a drink blender system with a single use disposable drink container, however the use of plastic materials for the mixing apparatus is inefficient for creating a proper vortex and the requisite sharpness to fully pulverize coarser and more granular particles. Additionally, the mixing apparatus is mounted on the bottom portion of the cup, making it liable to dislodge itself while the consumer is drinking from the cup. U.S. Patent Application Attorney Docket No R Basch 616 is for a drink blender system with a ribbed cup constructed with an interlocking design. The mixing apparatus is on the cup, not the lid, making it inapposite to the application on the lid.

In these respects, the drink blender system with a single use disposable lid according to the present invention substantially departs from the conventional concepts and designs of the prior art, and therefore provides an apparatus primarily developed for the purpose of permitting a user to dispose of the lid and mixing apparatus after a single use.

### SUMMARY OF THE INVENTION

In view of the foregoing disadvantages inherent in the known types of food blenders now present in the prior art, the present inventions provides a new drink blender system with a single use disposable lid construction wherein the same can be utilized for permitting a user to dispose of the lid and its attendant mixing apparatus after use.

To attain this, the present invention generally comprises a lid defining a ribbed interior to attach to a complementary-ribbed cup that attaches to the lid on the interior of the lid. The lid has an upper end which is open and it has a lower end. The upper end of the lid extends upward on the edges and contains a recess in the middle, so that the mixing apparatus located in the center of said lid may blend any constituents of a cup. The lower end of the lid, has a mixing apparatus integrally attached at the center, providing a recess underneath the mixing apparatus so that a driver shaft for the blender system can mate with the mixing apparatus and thereby actuate the mixing apparatus to rotate.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

One significant advantage of the present invention is the integration of the mixing apparatus with the lid to allow the disposal of the lid after a single use, leaving the cup free and clear of any of the elements of the mixing apparatus to promote the utmose safety in blending.

Further advantages of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The invention will be better understood and objects of the invention will become apparent when consideration is given to the following detailed description thereof. Such description makes reference to the annexed drawings, wherein:

FIG. 1 is a perspective view of a new drink blender system with a single use disposable lid according to the present invention.

### DESCRIPTION OF PREFERRED EMBODIMENTS

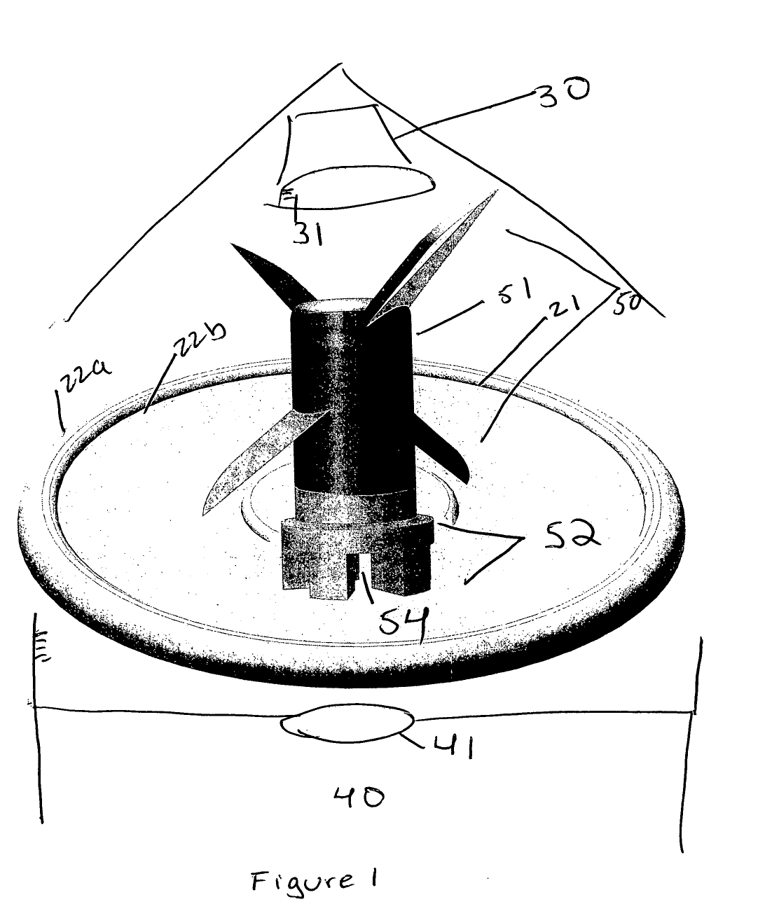

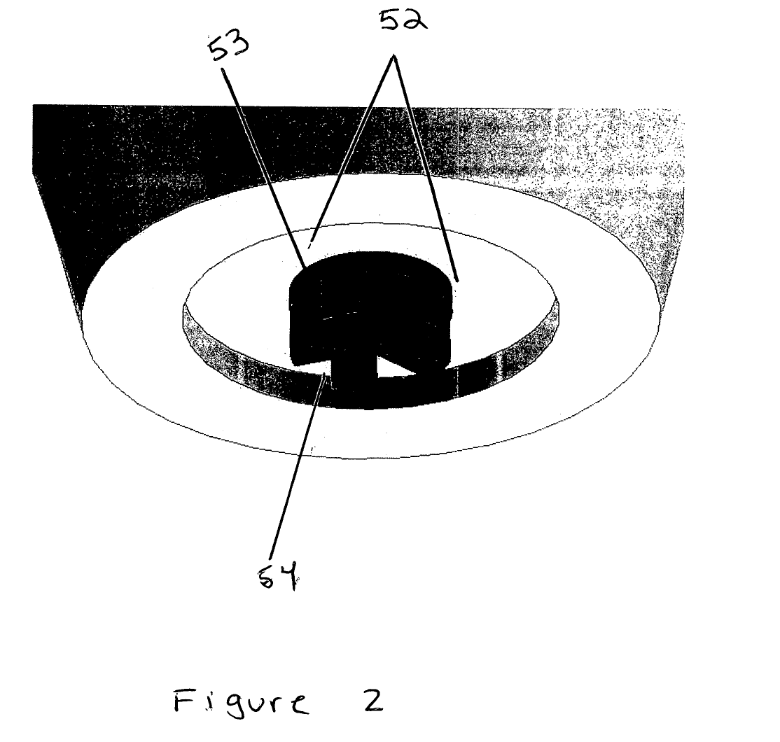

With reference now to the drawings, and in particular to FIG. 1 thereof, a new drink blender system with a single use disposable lid embodying the principles and concepts of the present invention and generally designated by the reference numeral 10 will be described.

As best illustrated in FIG. 1, the drink blender system with a single use disposable drink lid 10 generally comprises a lid 11 defining an interior 12 serving as an aperture to allow for the constituents to be blended with the lid 11 is mated with a corresponding cup 30 via the interior ribs 22a on the lid 11 and the cup ribs 31. The lid has an upper end 21 and a lower end 28.

The lid 11 comprises a wall 27 with interior ribs 22a and exterior ribs 22b. The interior ribs 22a allow for the lid 11 to mate with the cup ribs 31 so that the two may lock so that the contents of the cup 30 do not escape while blending. The exterior ribs 22b allow for the lid 11 to lock into the ribbed blender system wall 41 so that the lid 11 does not move while blending. The mixing apparatus 50 comprises a blade 51 that extends upward from the lower end 28 of the lid 11. The mixing apparatus 50 further comprises a blade 51 that extends upward from a 6 tooth-driver mate 52 that is supported by a metal driver support 53 to absorb some of the blender system 40 torque. The mixing apparatus 50 also contains an aperture 54 of the 6-tooth driver mate 52 to provide room for the driver shaft 41 to mate with and drive the mixing apparatus 50. The 6-tooth driver mate 52, may need some sort of sealing ring in order to prevent leakage. Said sealing ring may be employed in an alternate embodiment of the present invention. The driver shaft 41 is powered by the blender system 40.

Accordingly, when a cup 30 is locked in with the lid 11 through the cup ribs 31 locked into the interior ribs 22a of the lid 11, the lid 11 being further supported by the exterior ribs 22b held into place by the complementary ribbed blender system wall 41, the system 10 is ready for blending. When the blender 40 is powered, the driver shaft 41 is actuated and meets with the aperture 54 of the 6-tooth driver mate 52 to drive the mixing apparatus 50 to turn on its rotational axis, causing the blade 51 to create a vortex, thereby capable of pulverizing and otherwise blending the contents.

With respect to the above description then, it is to be realized that the optimum dimensional relationships for the parts of the invention, to include variations in size, materials, shape, form, function and manner of operation, assembly and use, are deemed readily apparent to one skilled in the art in light of the foregoing disclosure, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A system for blending a drink using a single use, disposable lid, the system comprising:
a single use, disposable lid defining an interior for receiving contents, the lid having an upper end and a lower end, and an interior and exterior ribbed outer wall, the lid having an opening into the interior;
a mixing apparatus integrally formed as a single unit with the lid, the mixing apparatus being mounted on the lower end of the lid, the mixing apparatus extending upwardly from the lower end into the interior of the lid; and
a driver assembly for driving the mixing apparatus to mix the contents of a cup, the lid and mixing apparatus being removably mounted on a driver assembly.

2. The system as set forth in claim 1, wherein the lid comprises a wall extending from the lower end to the upper end of the lid, the wall having a substantially ribbed exterior and interior for resting support on the blender system wall and to mate with a correspondingly ribbed cup.

3. The system as set forth in claim 2, wherein the lid comprises a perimeter wall irremovably mounted on the lower end to form the interior of the lid.

4. The system as set forth in claim 1, wherein the mixing apparatus comprises a pedestal irremovably mounted on the lid and extending into the interior of the cup, the pedestal having a bottom end positioned in a 6-tooth driver mate of the bottom end of the lid in a manner such that the bottom end of the pedestal extends from the lower end of the lid whereby it is able to mate with the driver shaft of a blender's driver shaft.

5. The system as set forth in claim 4, wherein the mixing apparatus further comprises a metal blade extending upwardly into the interior of the lid whereby allowing the blade to mix the contents.

6. The system as set forth in claim 4, wherein the 6-tooth driver mate is further supported by a metal support antagonistically shaped to the 6-tooth driver member whereby allowing the metal support to fit snugly into the 6-tooth member to absorb torque.

7. The system as set forth in claim, wherein the driver assembly comprises a base having a resting surface on an upper location on the base.

8. The system as set forth in claim 7, wherein the driver assembly comprises a driver shaft extending upwardly from the upper location of the base, the driver shaft being rotatable, the driver shaft having a free upper end configured to engage the mixing apparatus when the lid is rested on the resting surface of the base and otherwise mated with the ribbed blender system wall located on the base.

9. The system as set forth in claim 8, wherein the ribbed blender system wall located on the base has corresponding ribs to the ribs located on the exterior of the lids upper wall whereby allowing a locking of the lid to the blender system.
